(19) United States
(12) Patent Application Publication
(10) Pub. No.: US 2014/0257969 A1
(43) Pub. Date: Sep. 11, 2014

(54) METHODS AND APPARATUS TO MEASURE EXPOSURE TO MOBILE ADVERTISEMENTS

(71) Applicants: Alexander Pavlovich Topchy, New Port Richey, FL (US); Padmanabhan Soundararajan, Tampa, FL (US)

(72) Inventors: Alexander Pavlovich Topchy, New Port Richey, FL (US); Padmanabhan Soundararajan, Tampa, FL (US)

(21) Appl. No.: 13/793,771

(22) Filed: Mar. 11, 2013

(51) Int. Cl. G06Q 30/02

(52) U.S. Cl. CPC G06Q 30/0242
USPC 705/14.42; 705/14.41

(57) ABSTRACT

Methods and apparatus to measure exposure to mobile advertisements are disclosed. An example apparatus includes a panelist database containing first time-location data identifying a first set of physical locations of a first vehicle at corresponding points in time; an advertising vehicle database containing second time-location data identifying a second set of physical locations of a second vehicle at corresponding points in time, the second vehicle to display a first advertisement; and credit logic to determine whether to credit the first vehicle with an exposure to the first advertisement based on the first time-location data and the second time-location data.

### FIELD OF THE DISCLOSURE

This disclosure relates generally to audience measurement, and, more particularly, to methods and apparatus to measure exposure to mobile advertisements.

### BACKGROUND

Advertisements are sometimes placed on vehicles such as buses, trucks, taxicabs, rolling billboards, etc. Such advertisements are, thus, mobile, which allows the advertisements to move about a geographic area and potentially be seen by more people than a stationary advertisement. As vehicles with these mobile ads are driven around, drivers and passengers of nearby vehicles may see the ads. Pedestrians may also see the ads.

### BRIEF DESCRIPTION OF THE DRAWINGS

FIG. 1 illustrates an example environment in which an example system constructed in accordance with the teachings of this disclosure is implemented to measure exposure to mobile ads.

FIG. 2 illustrates the example environment of FIG. 1 from above and on a larger scale.

FIG. 3 is a block diagram of an example audience measurement system constructed in accordance with the teachings of this disclosure.

FIG. 4 is a block diagram of an example implementation of the panelist meter 104 of FIGS. 1 and 3.

FIG. 5 is a block diagram of an example implementation of the ad vehicle meter 110 of FIGS. 1 and 3.

FIG. 6 is a block diagram of an example implementation of the example ad exposure creditor 306 of FIG. 3.

FIG. 7 is a flowchart representative of example machine readable instructions that may be executed to implement the example panelist meter of FIGS. 1, 3 and 4.

FIG. 8 is a flowchart representative of example machine readable instructions that may be executed to implement the example ad vehicle meter of FIGS. 1, 3 and 5.

FIG. 9 is a flowchart representative of example machine readable instructions that may be executed to implement the example data receiver of FIG. 6.

FIG. 10 is a flowchart representative of example machine readable instructions that may be executed to implement the example ad exposure creditor of FIGS. 3 and 6.

FIG. 11 is a flowchart representative of example machine readable instructions that may be executed to implement the example occlusion detector of FIG. 6.

FIG. 12 is a flowchart representative of example machine readable instructions that may be executed to implement the example weight assigner of FIG. 6.

FIG. 13 is a flowchart representative of example machine readable instructions that may be executed to implement the example report generator of FIG. 6.

FIG. 14 illustrates an example report that may be generated by the example report generator of FIG. 6.

FIG. 15 is a block diagram of an example processing system capable of executing the example machine readable instructions of FIGS. 7-12 and/or 13 to implement the example panelist meter 104 of FIGS. 1, 3 and 4, the example ad vehicle meter 110 of FIGS. 1, 3 and 5, the example data receiver 600 of FIG. 6, the example ad exposure creditor 306 of FIGS. 3 and 6, the example occlusion detector 612 of FIG. 6, the example weight assigner 618 of FIG. 6, and/or the example report generator 622 of FIG. 6.

### DETAILED DESCRIPTION

Advertisements are sometimes displayed on vehicles such as trucks, buses, taxicabs, rolling billboards, etc. Such advertisements are, thus, mobile, which allows the advertisements to move about a geographical area and potentially be seen by more people than a stationary advertisement. As vehicles with these mobile ads are driven around, drivers and passengers of nearby vehicles may see the ads. Pedestrians may also see the ads.

Advertisers would like to know how many people are exposed to their advertisements. Advertisers would also like to know the demographic makeup of the people exposed to their advertisements. Such information allows advertisers to gauge the effectiveness of an ad campaign, to price ad placements and/or to selectively choose advertisements to appeal to certain demographics likely to be exposed to the ads. Accordingly, it would be useful for advertisers to know how many people are exposed to mobile ads. As used herein, mobile advertisements refer to any sort of advertisement (e.g., static or dynamic) present on and/or pulled by a vehicle). It would also be useful for advertisers to know the demographics of people exposed to such mobile ads.

Example methods, apparatus, and/or articles of manufacture disclosed herein facilitate measuring the number of people that are exposed to a mobile advertisement. Examples disclosed herein also facilitate measuring demographic information (e.g., age, gender, etc.) about the people that are exposed to a mobile advertisement. Examples disclosed herein use a panel of individuals with vehicles who are recruited to measure their exposure to mobile advertisements. In some such examples, the panelists' vehicles contain a meter to track the respective vehicle's location. In some examples, a panelist enters (i.e., inputs) the number of people in their vehicle into the meter. In other examples, a panelist enters (i.e., inputs) the identity or general demographic information about the people in their vehicle into the meter. In some examples, the demographics are implicitly entered by entering user IDs that are associated with the demographics of specific individuals. Such IDs can be used to retrieve the demographics from a database at a later date. In some examples, the meter is provided with location tracking functionality such as a global positions satellite (GPS) system, a cell phone triangulation system etc.

Examples disclosed herein also measure a plurality of advertising vehicles. In some such examples, the advertising vehicles contain external advertisements that can be seen by nearby pedestrians and/or persons in vehicles (e.g., passengers and/or drivers). In some examples, the advertising vehicles carry dynamic display devices which display multiple advertisements over time by periodically changing the advertisement being shown. In some such examples, the advertising vehicles also contain a meter comprising a location tracking device (e.g., a GPS system, a cell phone triangulation system, etc.) to track the advertising vehicle's location over time.

Examples disclosed herein analyze the travel path(s) and/or locations of the panelists and the advertising vehicles through the location tracking devices in the meters. Based on the travel path(s), examples disclosed herein detect when a panelist is within sufficiently close proximity of an advertising vehicle to attribute an exposure to an ad carried by the advertising vehicle to the panelist. When it is detected that an example panelist is within a threshold distance (e.g., 50 feet) of an example advertising vehicle, some examples disclosed herein record that the driver and all passengers in the panelist vehicle were exposed to the ad being displayed by the advertising vehicle.

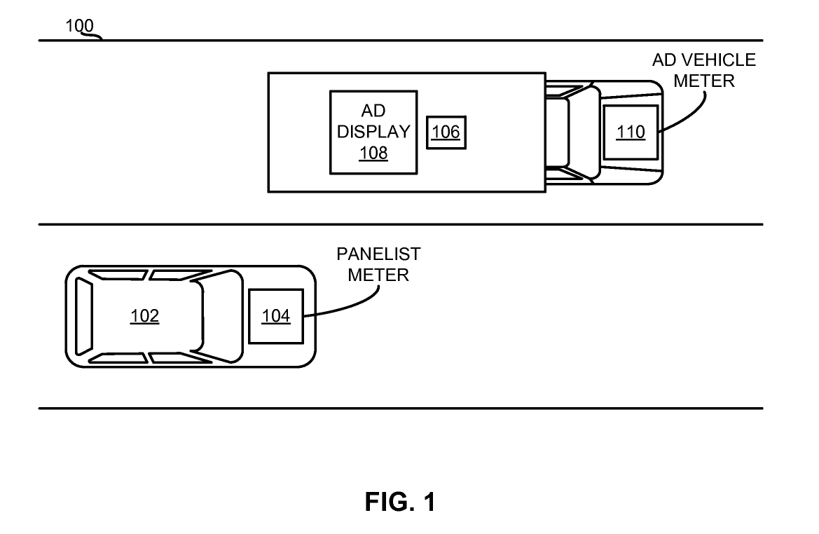

FIG. 1 illustrates an example environment in which an example system constructed in accordance with the teachings of this disclosure is implemented to measure exposure to mobile ads. The example of FIG. 1 includes a road or portion of a road 100, a panelist vehicle 102 and an ad vehicle 106.

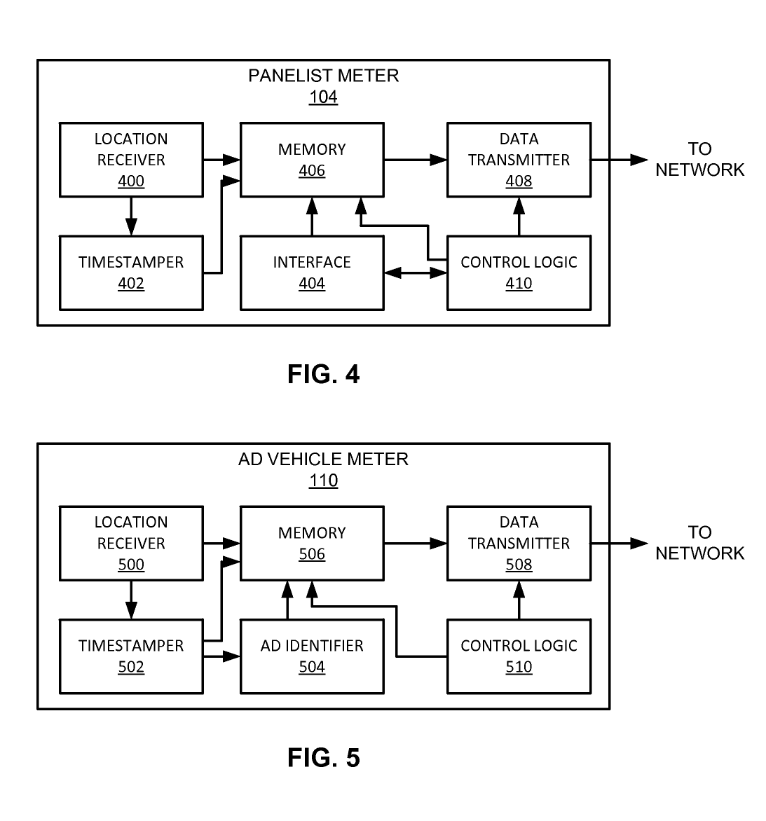

The panelist vehicle 102 of the illustrated example is driven by and/or transports an individual panelist. In the illustrated example, the panelist vehicle 102 contains a panelist meter 104 to monitor the location of the panelist vehicle 102. An example implantation of the panelist meter 104 is described in further detail in connection with FIG. 4.

The ad vehicle 106 of the illustrated example carries an ad display 108 to display one or more advertisements and an ad vehicle meter 110 to monitor the location of the ad vehicle 106. The example ad vehicle 106 may be a bus, a truck, a taxicab, a van, a car, a motorcycle, a rickshaw, a buggy, a rolling billboard, or any other type of vehicle capable of displaying an advertisement. The example ad display 108 may be a stationary display (e.g., a poster, an ad painted on the ad vehicle 106, a placard containing an advertisement) or a dynamic display (e.g., an electronic display with one or more ads displayed at the same and/or different times). Indeed, the display may be any type of display which is capable of displaying an ad that can be viewed by passengers and/or drivers of nearby vehicles and/or pedestrians. As mentioned above, in some examples, the ad display 108 is dynamic. In such examples, the ad display 108 cycles through (e.g., alternates) a number of advertisements (e.g., by changing the state of an electronic display, by physically rotating physical advertising materials, etc.). In such examples, the ad that can be seen by observers depends on when the ad display 108 is seen. In some such examples, the ad display 108 changes the displayed advertisement based on communication with the example data collection facility 304 (e.g., based on the demographic information of persons in a nearby panelist vehicle 102 as detected by the data collection facility 304).

In the illustrated example of FIG. 1, the panelist vehicle 102 and the ad vehicle 106 are both driving along the road 100. Because the example panelist vehicle 102 and the example ad vehicle 106 are in close proximity and in line of sight of the ad display 108, any persons in the panelist vehicle 102 can see the ad displayed by the example ad display 108. Therefore, the displayed ad is credited within an exposure to the example panelist and other passengers in the panelist vehicle 102 (if present).

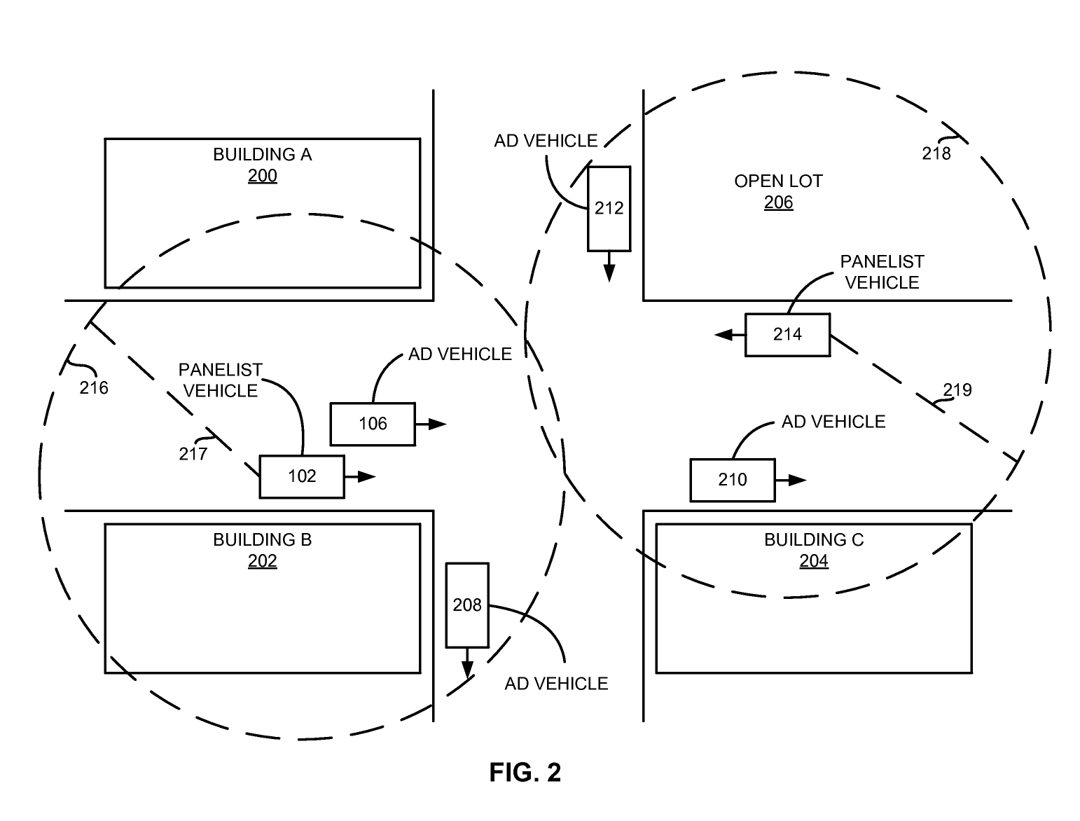

FIG. 2 is a top view of the example environment of FIG. 1. The example of FIG. 2 includes panelist vehicles 102 and 214, ad vehicles 106, 208, 210 and 212, building A 200, building B 202, building C 204 and open lot 206. The example panelist vehicles 102, 214 are associated with areas 216, 218 defined by rotating threshold radii 217, 219, respectively, centered at the panelist vehicles 102, 214 in a circle. The example threshold radii 217 and 219 are the distances from the example panelist vehicles 102 and 214, respectively, within which the system presumes the persons in the panelist vehicles 102 and 214, respectively, are able to see an advertisement. Accordingly, if an ad is within one of these areas 216, 218, the ad is credited with an exposure unless the ad is occluded from view (e.g., there is a geographic or other physical obstruction between the panelist and the ad).

In the illustrated example of FIG. 2, the ad vehicles 106 and 208 are within the area 216. However, the example ad vehicle 208 is occluded from view of the persons in the example panelist vehicle 102 by example building B 202. Therefore, the ad displayed by the example ad vehicle 208 is not credited with an exposure to the persons in the example panelist vehicle 102. However, the example ad vehicle 106 is not occluded from view of the persons in the example panelist vehicle 102 and the ad displayed by the ad vehicle 106 is credited with an exposure to the panelist vehicle 102 unless the ad vehicle 106 itself occludes the ad (e.g., the ad is on an opposite side of the vehicle 106 from the panelist vehicle 102).

In the illustrated example of FIG. 2, the ad vehicles 210 and 212 are within the area 218 of the panelist vehicle 214. The example ad vehicle 210 is not occluded from view of the persons in the example panelist vehicle 214. The example panelist vehicle 214 and the example ad vehicle 212 are separated by the example open lot 206. However, because the example open lot 206 does not contain a building, the example ad vehicle 212 is not occluded from the view of the persons in the example panelist vehicle 214. Therefore, the ads displayed on the example ad vehicle 210 and the example ad vehicle 212 are both credited with an exposure to the example panelist 214 unless the ad vehicle 106 itself occludes the ad (e.g., the ad is on an opposite side of the vehicle 106 from the panelist vehicle 102).

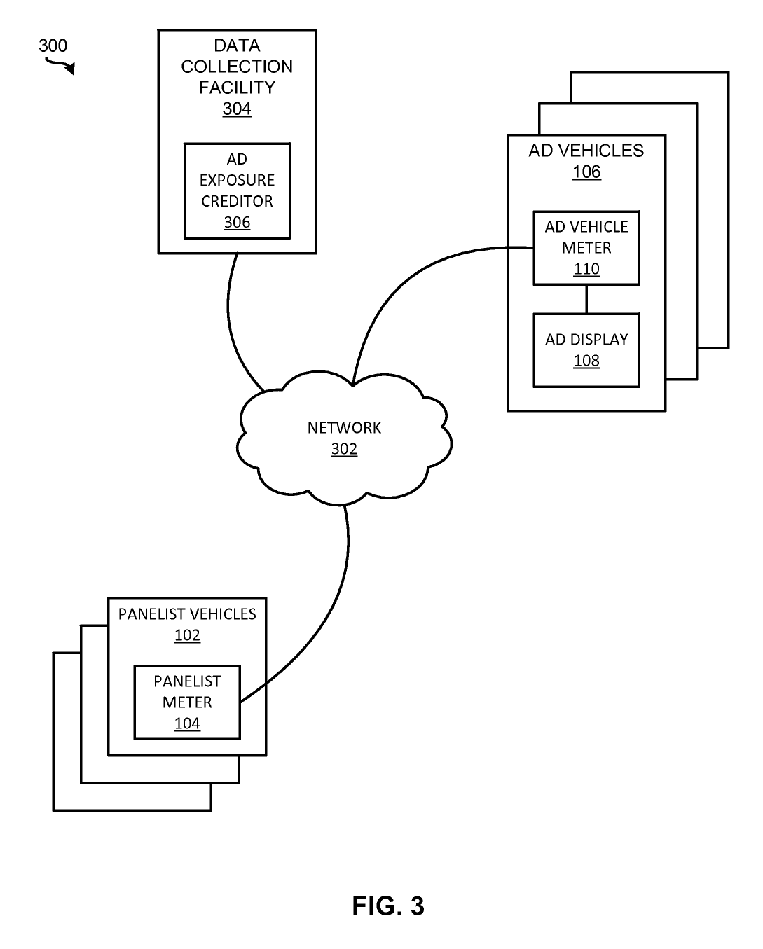

FIG. 3 is a block diagram of an example measurement system 300 constructed in accordance with the teachings of this disclosure. The example measurement system 300 includes panelist vehicles 102, ad vehicles 106 and a data collection facility 304.

In the illustrated example, the panelist vehicles 102 are each associated with one or more panelists. Panelists are individuals who agree to have their locations monitored while travelling in vehicles to measure their exposure to mobile advertisements. In the illustrated example, the panelists make up a panel and are selected to represent a population of interest. Alternatively, the panelists may be selected in any other manner. For example, the panelists may be selected to represent particular demographic groups such that the panel as a whole contains a mix of individuals similar to the demographics of the larger population that is to be measured. The example panelist vehicles 102 contain the example panelist meter 104, an example implementation of which is discussed in further detail in connection with FIG. 4.

In the illustrated example of FIG. 3, the ad vehicles 106 are vehicles (e.g., trucks, buses, taxicabs, etc.) that display ads. The example ad vehicles 106 carry one or more ad display(s) 108 to display one or more advertisements. In some examples, the example ad display(s) 108 are implemented by an electronic device that displays different ads at different times (e.g., by rotating or alternating ads). The ad vehicles 106 of the illustrated example carry the example ad vehicle meter 110, an example implementation of which is discussed in further detail in connection with FIG. 5.

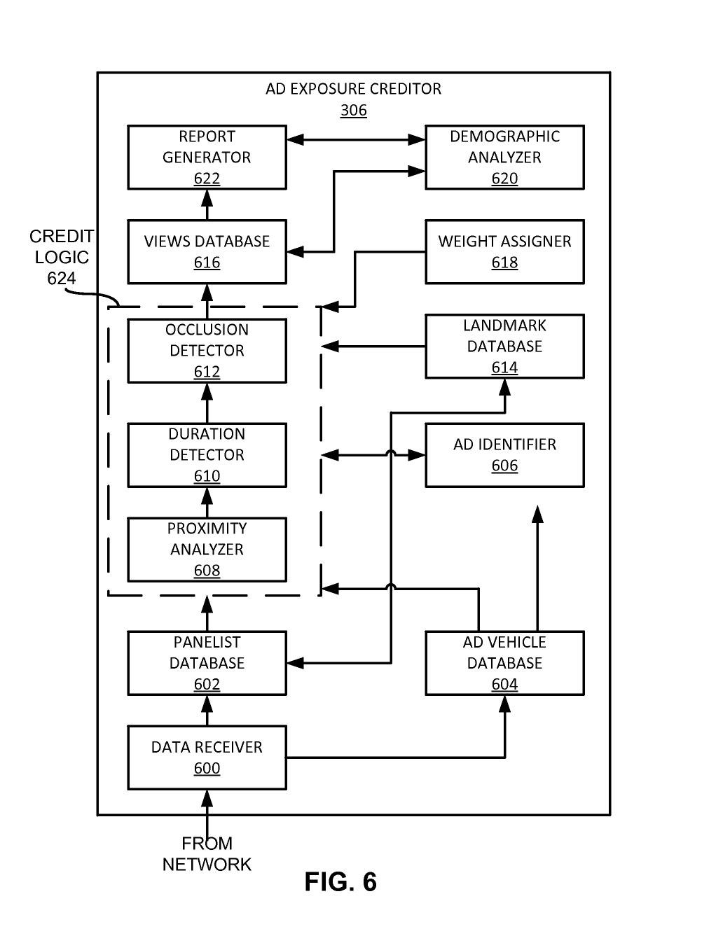

The data collection facility 304 of the illustrated example collects data from the example panelist vehicle 102 and the example ad vehicles 106. The example data collection facility 304 contains an ad exposure creditor 306, an example implementation of which is discussed in further detail in connection with FIG. 6.

In the illustrated example, the panelist vehicle 102 and the advertising vehicle 106 are able to communicate with the data collection facility 304 and vice versa via a network 302. The example network 302 of FIG. 3 allows a connection to be selectively made and/or torn down between (1) the example panelist vehicle(s) 102 and/or the example ad vehicle(s) 106 and (2) the example data collection facility 304. The example network 302 may be implemented using any type of public or private network such as, for example, the Internet, a telephone network, a local area network (LAN), a cable network, and/or a wireless network. To enable communication via the example network 302, the example panelist vehicles 102, the example ad vehicles 106 and the example data collection facility 304 of FIG. 3 of the illustrated example include a communication interface that enables connection to an Ethernet, a digital subscriber line (DSL), a telephone line, a coaxial cable and/or a wireless connection, etc.

FIG. 4 is a block diagram of an example implementation of the example panelist meter 104 of FIGS. 1 and 3. The example panelist meter 104 includes a location receiver 400, a timestamper 402, an interface 404, a memory 406, a data transmitter 408 and control logic 410.

The location receiver 400 of the illustrated example receives the current location of the example panelist meter 104. In the illustrated example, the location receiver 400 is a GPS receiver that generates a location based on signals received from the GPS satellite system. In other examples, other devices that can receive and/or detect a current location (e.g., using cell phone triangulation) may be used as the example location receiver 400.

The timestamper 402 of the illustrated example is a clock that associates a current time with data. In the illustrated example, the location receiver 400 and the timestamper 402 are integrated as a single GPS receiver that generates a location and a current time based on signals received from the GPS satellite system. In some examples, the timestamper 402 is a receiver that receives the current time from a cellular phone system. In some other examples, the timestamper 402 is a clock that keeps track of the time. Alternatively, any device that can receive and/or detect the current time may be used as the example timestamper 402.

The interface 404 of the illustrated example is an interactive device to prompt the panelist and/or other persons in the panelist vehicle 102 to input information and to receive information input by the panelist and/or other persons in the panelist vehicle 102. In the illustrated example, the interface 404 prompts or solicits the panelist and/or other persons in the panelist vehicle 102 to input information at the start of a driving trip. In some examples, the interface 404 prompts the panelist and/or other persons in the panelist vehicle 102 to enter the number of passengers in the vehicle. In some examples, the interface 404 prompts the panelist and/or other persons in the panelist vehicle 102 to enter demographic information about the panelist and/or other person(s) in the panelist vehicle 102. In some examples, the interface 404 prompts the panelist and/or other persons in the panelist vehicle 102 to enter the identities of the passengers in the panelist vehicle 102. In some examples, the interface 404 has a preset list of individuals (e.g, a list of the panelist's friends and/or family) and the interface 404 prompts the panelist and/or other persons in the panelist vehicle 102 to select which of the individuals from the list are passengers in the vehicle. In some examples, the interface 404 prompts the panelist and/or other persons in the panelist vehicle 102 to input as guests, the number of passengers in the vehicle who are not on the list. In some examples, the interface 404 allows the panelist and/or other persons in the panelist vehicle 102 to update the preset list of individuals who may be passengers by adding additional such individuals to the list. In some examples, the interface 404 prompts the panelist and/or other persons in the panelist vehicle 102 to answer survey questions. In some examples, the interface 404 prompts the panelist and/or other persons in the panelist vehicle 102 to answer survey questions based on an ad displayed by a nearby ad vehicle 106. In some examples, the interface 404 prompts the panelist and/or other persons in the panelist vehicle 102 to answer survey questions sent by a nearby ad vehicle 106 or a nearby ad vehicle meter 110. In the illustrated example, the interface 404 communicates with the control logic 410 to control the flow of the input and output of the interface 404.

The memory 406 of the illustrated example stores (1) data representative of physical locations of the panelist vehicle 102 received from the location receiver 400, (2) corresponding timestamps received from the timestamper 402 (e.g., time-location data) and (3) interface data received from the interface 404. The information in the memory 406 is accessible to the data transmitter 408. In the illustrated example, the memory 406 receives and stores location data from the location receiver 400, timestamps from the timestamper 402 and any information input by the persons in the panelist vehicle 102 via the interface 404. The example memory 406 communicates with the control logic 410. When the example memory 406 receives an appropriate command from the example control logic 410, the memory 406 sends its stored data to the data transmitter 408 and clears its memory. In the illustrated example, time-location data is data identifying the location(s) of a vehicle at different points in time.

The data transmitter 408 of the illustrated example receives data from the memory 406 and transmits the data to the data collection facility 304 via the network 302. The example data transmitter 408 communicates with the example control logic 410 and transmits the data stored in the memory 406 when instructed to do so by the control logic 410. The example data transmitter 408 also transmits a panelist ID indicating which of the example panelist vehicles 102 the data is being transmitted from. In the illustrated example, a panelist ID is a unique identifier associated with a panelist that is assigned to a person when the person becomes a panelist. In some examples, a panelist ID is a unique identifier associated with a panelist meter 104 that is assigned when a person becomes a panelist. When the example data collection facility 304 receives the data, it uses the received panelist ID to keep track of data received from each of the example panelist vehicles 102. In the illustrated example, the data transmitter 408 transmits data after a certain amount of time has passed since the previous transmission (e.g., every ten minutes). In some examples, the data transmitter 408 transmits data at a certain time every day (e.g., every day at midnight). In some examples, the data transmitter 408 transmits data whenever the data in the memory 406 reaches a certain size (e.g., 80% of the capacity of the memory 406).

The control logic 410 of the illustrated example controls the operation of the panelist meter 104. In the illustrated example, the control logic 410 controls the operation of the interface 404 by causing surveys to appear, input fields to be displayed, selection choices to be displayed, etc. The example control logic 410 of FIG. 4 further communicates with the example memory 406 and instructs the memory 406 when to send its stored data to the example data transmitter 408. In some examples, the control logic 410 monitors the size of the data stored in the memory 406 relative to the capacity of the memory 406. The example control logic 410 further communicates with the example data transmitter 408 and instructs the data transmitter 408 when to transmit data to the example data collection facility 304 via the network 302.

While an example manner of implementing the panelist meter of FIGS. 1 and 3 is illustrated in FIG. 4, one or more of the elements, processes and/or devices illustrated in FIG. 4 may be combined, divided, re-arranged, omitted, eliminated and/or implemented in any other way. Further, the example location receiver 400, the example timestamper 402, the example interface 404, the example memory 406, the example data transmitter 408, the example control logic 410, and/or, more generally, the example panelist meter 104 of FIG. 4 may be implemented by hardware, software, firmware and/or any combination of hardware, software and/or firmware. Thus, for example, any of the example location receiver 400, the example timestamper 402, the example interface 404, the example memory 406, the example data transmitter 408, the example control logic 410, and/or, more generally, the example panelist meter 104 of FIG. 4 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example location receiver 400, the example timestamper 402, the example interface 404, the example memory 406, the example data transmitter 408, the example control logic 410, and/or, more generally, the example panelist meter 104 of FIG. 4 are hereby expressly defined to include a tangible computer readable storage device or storage disc such as a memory, DVD, CD, Blu-ray, etc. storing the software and/or firmware. Further still, the example panelist meter of FIG. 4 may include one or more elements, processes and/or devices in addition to, or instead of, those illustrated in FIG. 4, and/or may include more than one of any or all of the illustrated elements, processes and devices.

FIG. 5 is a block diagram of an example implementation of the example ad vehicle meter 110 of FIGS. 1 and 3. The example ad vehicle meter 110 includes a location receiver 500, a timestamper 502, an ad identifier 504, a memory 506, a data transmitter 508 and control logic 510.

The location receiver 500 of the illustrated example receives the current location of the example ad vehicle meter 110. In the illustrated example, the location receiver 500 is a GPS receiver that generates a location based on signals received from the GPS satellite system. In other examples, other devices that can receive and/or detect a current location (e.g., using cell phone triangulation) may be used as the example location receiver 500.

The timestamper 502 of the illustrated example is a clock that associates a current time with data. In the illustrated example, the location receiver 500 and the timestamper 502 are integrated as a single GPS receiver that generates a location and a current time based on signals received from the GPS satellite system. In some examples, the timestamper 502 is a receiver that receives the current time from a cellular phone system. In some other examples, the timestamper 502 is a clock that keeps track of the time. Alternatively, any device that can receive and/or detect the current time may be used as the example timestamper 502. In some examples, the timestamper 402 in the panelist meter 104 is synchronized to the timestamper 502 in the ad vehicle meter 110 such that each timestamp received by the timestamper 402 in the panelist meter 104 is the same as a timestamp received by the timestamper 502 in the ad vehicle meter 110.

The ad identifier 504 of the illustrated example identifies the ad displayed by the ad display 108. In examples where the ad displayed by the ad display 108 does not change (e.g., the ad display 108 is static (e.g., a poster)), the ad identifier 504 always identifies the same ad. In examples where the ad display 108 alternates two or more displayed ads (e.g., an electronic display), the ad identifier 504 identifies the ad currently displayed by the ad display 108. In the illustrated example, the ad identifier 504 identifies the ad currently displayed by the ad display 108 by outputting an ad ID of the displayed ad. The ad ID is timestamped via the timestamper 502 to identify when the ad was presented for display. In addition, the example ad identifier 504 identifies where on the example ad vehicle 106 the example ad display 108 is located (e.g., back, roof, right door, hood, forward facing, rear facing, right side facing, left side facing, etc.).

The memory 506 of the illustrated example stores (1) locations received from the location receiver 500, (2) corresponding timestamps received from the timestamper 502 (e.g., time-location data) and (3) ad IDs received from the ad identifier 504. The information in the memory 506 is accessible to the data transmitter 508. In the illustrated example, the memory 506 receives and stores location data from the location receiver 500, timestamps from the timestamper 502 and any ad IDs from the ad identifier 504. The example memory 506 communicates with the example control logic 510. When the example memory 506 receives an appropriate command from the example control logic 506, the memory 506 sends its stored data to the example data transmitter 508 and clears its memory.

The data transmitter 508 of the illustrated example receives data from the memory 506 and transmits the data to the data collection facility 304 via the network 302. The example data transmitter 508 communicates with the example control logic 510 and transmits the data stored in the example memory 506 when instructed to do so by the control logic 510. The example data transmitter 508 also transmits an ad vehicle ID indicating which of the example ad vehicles 106 the data is being transmitted from. When the example data collection facility 304 receives the data, it uses the ad vehicle ID to keep track of data received from each of the example ad vehicles 106. In the illustrated example, the data transmitter 508 transmits data after a certain amount of time has passed since the previous transmission (e.g., every ten minutes). In some examples, the data transmitter 508 transmits data at a certain time every day (e.g., every day at midnight). In some examples, the data transmitter 508 transmits data whenever the data in the memory 506 reaches a certain size (e.g., 80% of the capacity of the memory 506).

The control logic 510 of the illustrated example controls the operation of the ad vehicle meter 110. In the illustrated example, the control logic 510 of FIG. 5 communicates with the memory 506 and instructs the memory 506 when to send its stored data to the example data transmitter 508. In some examples, the control logic 510 monitors the size of the data stored in the memory 506 relative to the capacity of the memory 506. The example control logic 510 further communicates with the example data transmitter 508 and instructs the data transmitter when to transmit data to the example data collection facility 304 via the network 302.

While an example manner of implementing the ad vehicle meter of FIGS. 1 and 3 is illustrated in FIG. 5, one or more of the elements, processes and/or devices illustrated in FIG. 5 may be combined, divided, re-arranged, omitted, eliminated and/or implemented in any other way. Further, the example location receiver 500, the example timestamper 502, the example ad identifier 504, the example memory 506, the example data transmitter 508, the example control logic 510, and/or, more generally, the example ad vehicle meter 110 of FIG. 5 may be implemented by hardware, software, firmware and/or any combination of hardware, software and/or firmware. Thus, for example, any of the example location receiver 500, the example timestamper 502, the example ad identifier 504, the example memory 506, the example data transmitter 508, the example control logic 510, and/or, more generally, the example ad vehicle meter 110 of FIG. 5 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example location receiver 500, the example timestamper 502, the example ad identifier 504, the example memory 506, the example data transmitter 508, the example control logic 510, and/or, more generally, the example ad vehicle meter 110 of FIG. 5 are hereby expressly defined to include a tangible computer readable storage device or storage disc such as a memory, DVD, CD, Blu-ray, etc. storing the software and/or firmware. Further still, the example ad vehicle meter of FIG. 5 may include one or more elements, processes and/or devices in addition to, or instead of, those illustrated in FIG. 5, and/or may include more than one of any or all of the illustrated elements, processes and devices.

FIG. 6 is a block diagram of an example implementation of the example ad exposure creditor 306 of FIG. 3. The example ad exposure creditor 306 includes a data receiver 600, a panelist database 602, an advertising vehicle database 604, an ad identifier 606, a landmark database 614, a view database 616, a weight assigner 618, a demographic analyzer 620, a report generator 622 and credit logic 624.

The data receiver 600 of the illustrated example receives data from the panelist meter 104 and/or the ad vehicle meter 110 of the panelist vehicles 102 and the ad vehicles 106, respectively, via the network 302. The data received by the example data receiver 600 from an example panelist meter 104 includes a series of corresponding timestamped locations (e.g., time-location data), interface data (e.g., person identification data, survey answers, etc.) and a panelist ID (e.g., an alphanumeric code identifying the panelist vehicle 102 from which the data is received). The example data receiver 600 stores data received from an example panelist meter 104 in the example panelist database 602.

The data received by the example data receiver 600 from the example ad vehicle meter 110 includes a series of timestamped locations (e.g., time-location data), ad IDs (e.g., alphanumeric identifiers identifying displayed ads, locations of displayed ads and, for dynamic ads, times at which such ads were displayed) and an ad vehicle ID (e.g., an alphanumeric identifier identifying the ad vehicle). The example data receiver 600 stores data received from an example ad vehicle meter 110 in the ad vehicle database 604.

The panelist database 602 of the illustrated example stores data received from the panelist meter 104 of the panelist vehicles 102. The example panelist database 602 uses the panelist IDs to organize the timestamped locations and the interface data by the example panelist vehicle 102 that sent the data. Any or all databases described herein, including the panelist database 602, may be implemented by any storage device and/or storage disc for storing data such as, for example, flash memory, magnetic media, optical media, etc. Furthermore, the data stored in the panelist database 602 and any or all databases described herein may be in any data format such as, for example, binary data, comma delimited data, tab delimited data, structured query language (SQL) structures, etc. While in the illustrated example the panelist database 602 is illustrated as a single database, the panelist database 602 and any or all databases described herein may be implemented by any number and/or type(s) of databases.

The ad vehicle database 604 of the illustrated example stores data received from the ad vehicle meters 110 of the ad vehicles 106. The example ad vehicle database 604 uses the ad vehicle IDs to organize the timestamped locations and the ad IDs by the example ad vehicle 106 that sent the data.

The ad identifier 606 of the illustrated example identifies an advertisement that was displayed by the ad display 108 of an ad vehicle 106 by accessing the advertising vehicle database 604 using the ad ID of the advertisement in question as a query term. The ad ID is tied to the name, size, owner, and/or other features for a corresponding ad in the ad vehicle database 604. The example ad identifier 606 communicates with the example credit logic 624.

The landmark database 614 of the illustrated example contains locations of potential geographic obstructions (e.g., buildings, mountains, etc.). Data in the landmark database 614 correlates GPS coordinates to various fixed physical structures in an environment such as buildings, fields, lots, billboards, towers, open lots and/or other structures. The example landmark database 614 communicates with the example credit logic 624.

The weight assigner 618 of the illustrated example assigns one or more weighting factors to be used by the credit logic 624. In the illustrated example, the weighting factors assigned by the weight assigner 618 are selected from a list. In other examples, the weighting factors may be changed dynamically. The weighting factors assigned by the example weight assigner 618 may be based on, for example, a distance between a panelist vehicle 102 and an ad vehicle 106 and/or a duration of time that a panelist vehicle 102 was within a certain distance from an ad vehicle 106.

The credit logic 624 of the illustrated example determines whether to credit an ad displayed by the ad display 108 of an ad vehicle 106 with exposure to a panelist vehicle 102. The credit logic 624 of the illustrated example includes a proximity analyzer 608, a duration detector 610 and an occlusion detector 612.

The proximity analyzer 608 of the illustrated example determines whether a panelist vehicle 102 and an ad vehicle 106 were within a threshold distance from each other by accessing the time-location data in the panelist database 602 and the ad vehicle database 604. In the illustrated example, the threshold distance is a predetermined distance, wherein a panelist vehicle 102 separated from an ad vehicle 106 by less than the threshold distance is likely to view and understand an advertisement displayed by the vehicle 106. In some examples, the proximity analyzer 608 determines the distance between an example panelist vehicle 102 and an example ad vehicle 106 at a specific point in time and compares the determined distance to the threshold distance. If the determined distance is larger than the threshold distance, then no exposure is recorded. If the determined distance is less than the threshold distance, then an exposure may be recorded depending on the analysis of the duration detector 610, the analysis of the occlusion detector 612 and/or other factors discussed in this disclosure.

The duration detector 610 of the illustrated example determines the amount of time that a panelist vehicle 102 was within the threshold distance from an ad vehicle 106. In the illustrated example, the duration detector 610 further determines the amount of time that a panelist vehicle 102 was within a particular range of distances from the ad vehicle 106. For example, if the threshold distance is 40 feet, the duration detector 610 might determine the amount of time that the panelist vehicle 102 was less than 10 feet from the ad vehicle 106, the amount of time that the panelist vehicle 102 was between 10 feet and 20 feet from the ad vehicle 106, the amount of time that the panelist vehicle 102 was between 20 feet and 30 feet from the ad vehicle 106, and the amount of time that the panelist vehicle 102 was between 30 feet and 40 feet from the ad vehicle 106. Additionally or alternatively, any other ranges of distances between the panelist vehicle 102 and the ad vehicle 106 within the threshold distance may be determined by the duration detector 610.

When the example proximity analyzer 608 determines that a panelist vehicle 102 and an ad vehicle 106 were within a threshold distance of each other at a particular time, the example duration detector 610 records the time. The example duration detector 610 then analyzes the time-location data for the panelist vehicle 102 from the example panelist database 602 and the time-location data for the ad vehicle 106 from the example ad vehicle database 604 for points in time after the recorded time. The example duration detector 610 determines whether the panelist vehicle 102 and the ad vehicle 106 were still within the threshold distance of each other (e.g., less than 40 feet) for each successive time after the recorded time. In the illustrated example, the duration detector 610 further determines whether the panelist vehicle 102 and the ad vehicle 106 were still within a particular range of distances from each other (e.g., between 10 feet and 20 feet) for each successive time after the recorded time. When the example duration detector 610 finds a point in time at which the panelist vehicle 102 and the ad vehicle 106 were no longer within the threshold distance of each other, the duration detector 610 records that time. In the illustrated example, the duration detector 610 determines the difference between the first recorded time at which the vehicles were determined to be within the threshold distance and the last recorded time at which the vehicles were determined to be within the threshold distance and outputs this as the amount of time that the panelist vehicle 102 was within the range of distances of the ad vehicle 106. In some examples, the duration detector 610 outputs the time difference as the amounts of time that the panelist vehicle 102 was within the various ranges of distances of the ad vehicle 106 (e.g., 10 seconds in the 0-10 feet range, 55 seconds in the 10-20 feet range, etc.).

The occlusion detector 612 of the illustrated example determines whether an ad on an ad vehicle 106 was occluded from the view of persons in a panelist vehicle 102 at a particular time by accessing the time-location data from the panelist database 602 and the ad vehicle database 604 and accessing data from the landmark database 614.

There are two types of occlusion that can prohibit persons in a panelist vehicle 102 from seeing an ad on an ad vehicle 106 that is within the threshold distances of the panelist vehicle 102. The first type of occlusion occurs when the ad display 108 on the ad vehicle 106 is on the opposite side of the ad vehicle 106 from the panelist vehicle 102 (e.g., the ad faces away from the panelist vehicle 102). The example occlusion detector 612 detects this type of occlusion by determining the direction of travel of the panelist vehicle 102, determining the direction of travel of the ad vehicle 106, determining where on the ad vehicle 106 the ad display 108 is located, and determining whether there is a line of sight between the panelist vehicle 102 and the ad display 108.

The second type of occlusion occurs when there is an obstruction between the panelist vehicle 102 and the ad vehicle 106. The example occlusion detector 612 detects this type of occlusion by accessing the example landmark database 614 and determining whether there are any landmarks (e.g., buildings, hills, etc.) between the panelist vehicle 102 and the ad vehicle 106 and by accessing the ad vehicle database 604 and the panelist database 602 to identify large vehicles positioned between the panelist vehicle 102 in question and the ad vehicle 106 in question to determine if the line of sight is blocked.

The views database 616 of the illustrated example receives and stores the output of the credit logic 624. In the illustrated example, for every ad displayed by the ad display 108 of the ad vehicles 106, the views database stores the number of exposures of the ad to the panelist vehicles 102, the duration of each exposure, the distance between the corresponding panelist vehicle 102 and ad vehicle 106 during each exposure, and the demographic information of the persons in the panelist vehicle 102 exposed to the ad during each exposure.

The report generator 622 of the illustrated example generates reports based on the information stored in the views database 616. In the illustrated example, the report generator 622 generates reports listing the exposures of one or more ads to one or more panelist vehicles 102. The report generator 622 may generate any type(s) of reports. For example, the report generator 622 may generate reports focused on certain ads, certain panelists (e.g., panelists meeting certain demographic criteria), exposures occurring during certain time periods (e.g., between 2:00-4:00 P.M.), or focused on any other information and/or subset of information in the views database 616.

The demographic analyzer 620 of the illustrated example analyzes the demographic information in the views database 616. The example demographic analyzer 620 communicates with the report generator 622 when the report generator 622 generates reports related to the demographic information of panelists.

While an example manner of implementing the ad exposure creditor of FIG. 3 is illustrated in FIG. 6, one or more of the elements, processes and/or devices illustrated in FIG. 6 may be combined, divided, re-arranged, omitted, eliminated and/or implemented in any other way. Further, the example data receiver 600, the example panelist database 602, the example ad vehicle database 604, the example ad identifier 606, the example proximity analyzer 608, the example duration detector 610, the example occlusion detector 612, the example landmark database 614, the example views database 616, the example weight assigner 618, the example demographic analyzer 620, the example report generator 622, the example credit logic 624 and/or, more generally, the example ad exposure creditor of FIG. 6 may be implemented by hardware, software, firmware and/or any combination of hardware, software and/or firmware. Thus, for example, any of the example data receiver 600, the example panelist database 602, the example ad vehicle database 604, the example ad identifier 606, the example proximity analyzer 608, the example duration detector 610, the example occlusion detector 612, the example landmark database 614, the example views database 616, the example weight assigner 618, the example demographic analyzer 620, the example report generator 622, the example credit logic 624 and/or, more generally, the example ad exposure creditor 306 of FIG. 6 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example, data receiver 600, the example panelist database 602, the example ad vehicle database 604, the example ad identifier 606, the example proximity analyzer 608, the example duration detector 610, the example occlusion detector 612, the example landmark database 614, the example views database 616, the example weight assigner 618, the example demographic analyzer 620, the example report generator 622, the example credit logic 624 and/or, more generally, the example ad exposure creditor of FIG. 6 are hereby expressly defined to include a tangible computer readable storage device or storage disc such as a memory, DVD, CD, Blu-ray, etc. storing the software and/or firmware. Further still, the example ad exposure creditor of FIG. 3 may include one or more elements, processes and/or devices in addition to, or instead of, those illustrated in FIG. 6, and/or may include more than one of any or all of the illustrated elements, processes and devices.

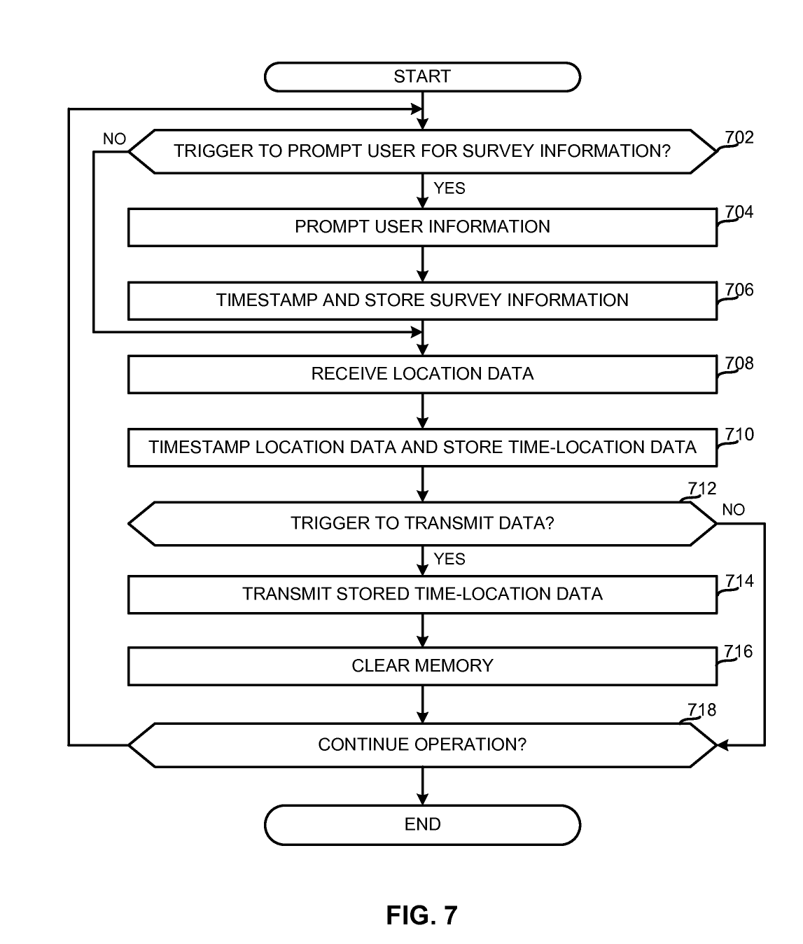

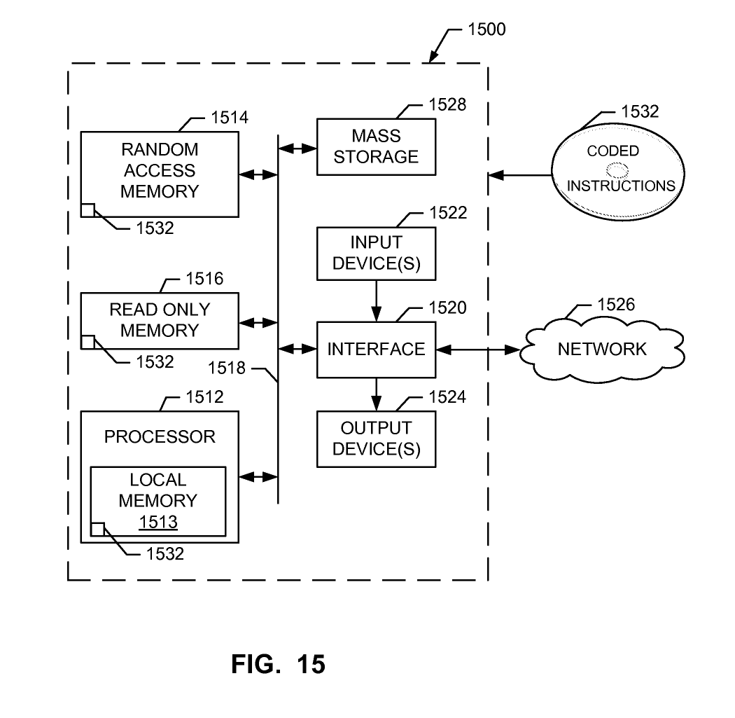

Flowcharts representative of example machine readable instructions for implementing the example panelist meter 104 of FIGS. 1, 3 and 4, the example ad vehicle meter 110 of FIGS. 1, 3 and 5, the example data receiver 600 of FIG. 6, the example ad exposure creditor 306 of FIGS. 3 and 6, the example occlusion detector 612 of FIG. 6, the example weight assigner 618 of FIG. 6, and/or the example report generator 622 of FIG. 6 are shown in FIGS. 7-13. In this example, the machine readable instructions comprise a program for execution by a processor such as the processor 1512 shown in the example processor platform 1500 discussed below in connection with FIG. 15. The program may be embodied in software stored on a tangible computer readable storage medium such as a CD-ROM, a floppy disk, a hard drive, a digital versatile disk (DVD), a Blu-ray disk, or a memory associated with the processor 1512, but the entire program and/or parts thereof could alternatively be executed by a device other than the processor 1512 and/or embodied in firmware or dedicated hardware. Further, although the example program is described with reference to the flowcharts illustrated in FIGS. 7-13, many other methods of implementing the example panelist meter 104 of FIGS. 1, 3 and 4, the example ad vehicle meter 110 of FIGS. 1, 3 and 5, the example data receiver 600 of FIG. 6, the example ad exposure creditor 306 of FIGS. 3 and 6, the example occlusion detector 612 of FIG. 6, the example weight assigner 618 of FIG. 6, and the example report generator 622 of FIG. 6 may alternatively be used. For example, the order of execution of the blocks may be changed, and/or some of the blocks described may be changed, eliminated, performed in parallel (e.g., in parallel threads) or combined.

As mentioned above, the example processes of FIGS. 7-13 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 7-13 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 7 is a flowchart representative of example machine readable instructions for implementing the example panelist meter 104 of FIGS. 1, 3 and 4. FIG. 7 begins when the example control logic 410 determines whether to prompt the example panelist for survey information (block 702). This determination may be based on various factors such as, for example, a signal from the data collection facility 304, a signal from an ad vehicle 106, a recognition of proximity to an ad vehicle 106, a time, a need for demographic information, starting of the panelist vehicle 102, a closing of a door of the panelist vehicle 102, etc. If the example control logic determines that the example panelist is to be prompted for survey information (block 702), then the example interface 404 prompts the panelist to input the appropriate information (block 704). After the example panelist enters a response to the survey information into the example interface 404, the interface 404 records the response in the example memory 406 and the example timestamper 402 records a corresponding timestamp in the memory 406 (block 706).

At block 708, the example location receiver 400 receives data representative of the location of the example panelist meter 104 (block 708). The example location receiver 400 records the received location in the example memory 406 and the example timestamper 402 records a corresponding timestamp in the memory 406 indicating the time at which the location data was received (block 710).

The example control logic 410 determines whether to transmit the data in the example memory 406 based on the configuration of the example panelist meter 104 (e.g., based on the time of day, the time elapsed since the previous transmission, the amount of data stored in the memory 406, etc.) (block 712). If the example control logic 410 determines that the data in the example memory 406 should be transmitted (block 712), then the example data transmitter 408 transmits the data in the memory 406 to the example data collection facility 304 via the example network 302 (block 714). The example memory 406 then clears its contents (block 716).

After the example memory 406 clears its contents (block 716) or after the example control logic 410 determines that the data in the memory 406 should not be transmitted (block 712), the control logic 410 determines whether to continue operation of the example panelist meter 104 (block 718). This determination may be made, for example, based on the operating state of the panelist vehicle 102. If the example control logic 410 determines that operation of the example panelist meter 104 should continue (block 718), then control returns to block 702. If the example control logic 410 determines that operation of the example panelist meter 104 should not continue (block 718), then the example process of FIG. 7 ends. By repeatedly looping through blocks 708-710, the panelist meter 104 collects a plurality of time-location data points.

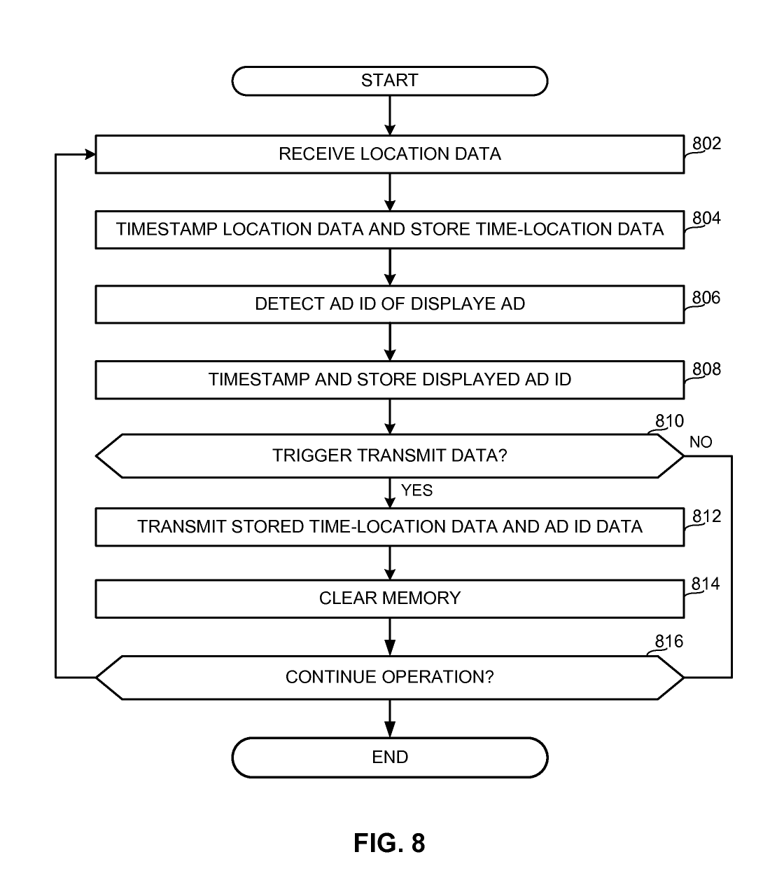

FIG. 8 is a flowchart representative of example machine readable instructions for implementing the example ad vehicle meter 110 of FIGS. 1, 3 and 5. FIG. 8 begins when the example location receiver 500 receives the location of the example ad vehicle meter 110 (block 802). The example location receiver 500 records the received location in the example memory 506 and the example timestamper 502 records a corresponding timestamp in the memory 506 to generate time-location data (block 804).

The example ad identifier 504 detects the ad ID of the advertisement displayed by the example ad display 108 (block 806). The example ad identifier 504 stores the detected ad ID in the example memory 506 and the example timestamper 502 stores a corresponding timestamp in the memory 506 (block 808).

The example control logic 510 then determines whether to transmit the data in the example memory 506 (e.g., based on the time of day, the time elapsed since the previous transmission, the amount of data stored in the memory 506, etc.) (block 810). If the example control logic 510 determines that the data in the example memory 506 should be transmitted (block 810), then the example data transmitter 508 transmits the data in the memory 506 to the example data collection facility 304 via the example network 302 (block 812). The example memory 506 then clears its contents (block 814).

After the example memory 506 clears its contents (block 814) or after the example control logic 510 determines that the data in the memory 506 should not be transmitted (block 810), the control logic 510 determines whether to continue operation of the example ad vehicle meter 110. This determination may be made, for example, based on the operating state of the ad vehicle 106. If the example control logic 510 determines that operation of the example ad vehicle meter 110 should continue (block 816), then control returns to block 802.1f the example control logic 510 determines that operation of the example ad vehicle meter 110 should not continue (block 816), then the example process of FIG. 8 ends.

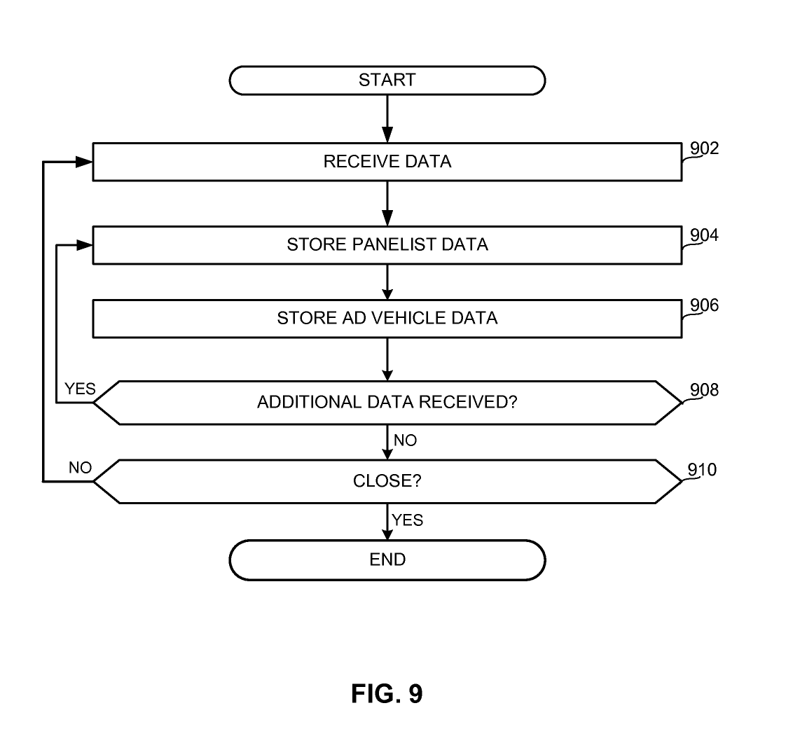

FIG. 9 is a flowchart representative of example machine readable instructions for implementing the example data receiver 600 of FIG. 6. FIG. 9 begins when the example data receiver 600 receives data via the example network 302 (block 902). The example data receiver 600 then stores data received from an example panelist meter 104 (e.g., panelist data, time-location data, survey data, etc.) in the example panelist database 602 (block 904). The example data receiver 600 then stores data received from an example ad vehicle meter 110 (e.g., time-location data, ad identification data, etc.) in the example ad vehicle database 604 (block 906).

The example data receiver 600 then determines whether it has received additional data (block 908). If the example data receiver 600 has received additional data (block 908), then control returns to block 904. If the example data receiver 600 has not received additional data (block 908), then the data receiver 600 determines whether to discontinue data reception (block 910). If the example data receiver 600 determines not to discontinue data reception (block 910), then control returns to block 902. If the example data receiver 600 determines to discontinue data reception (block 910), then the example process of FIG. 9 ends.

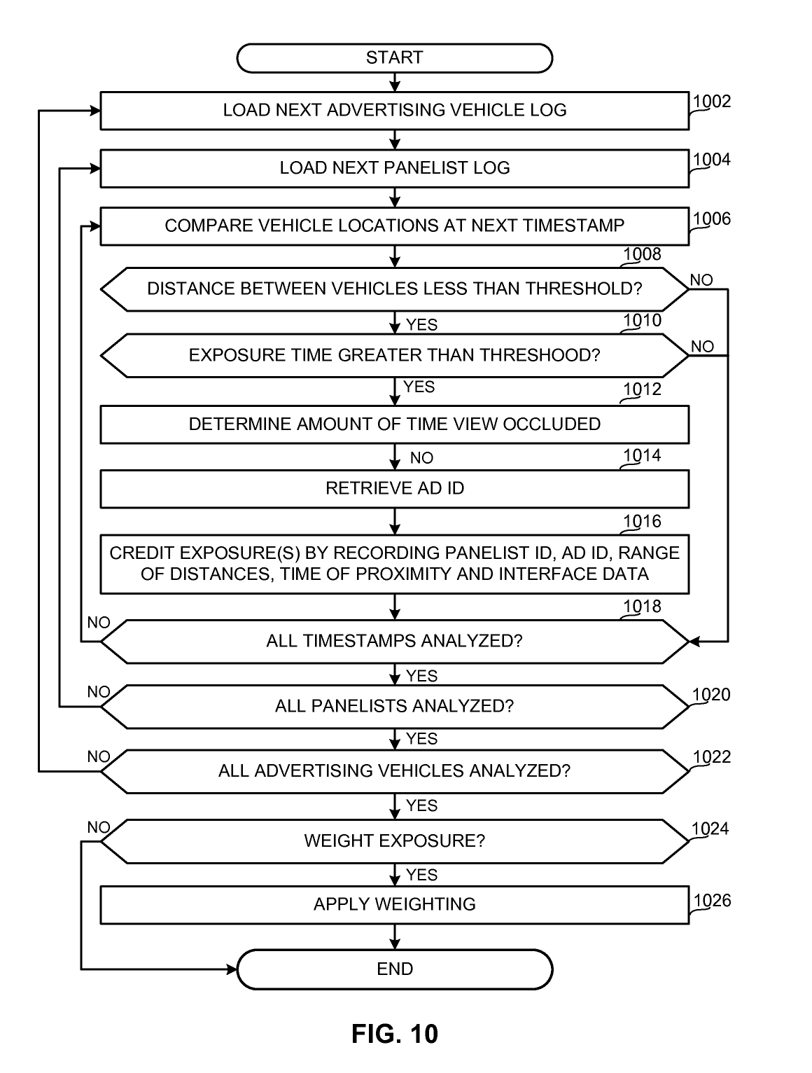

FIG. 10 is a flowchart representative of example machine readable instructions for implementing the example ad exposure creditor 306 of FIGS. 3 and 6. The example of FIG. 10 begins when the example credit logic 624 loads time-location data from the example ad vehicle database 604 related to one example ad vehicle meter 110 in an example ad vehicle 106 (e.g., an advertising vehicle log) (block 1002). The example credit logic 624 then loads the time-location data from the example panelist database 602 related to one panelist meter 104 in an example panelist vehicle 102 (e.g., a panelist log) (block 1004).

The example proximity analyzer 608 then compares the location of the panelist vehicle 102 corresponding to the loaded panelist log to the location of the ad vehicle 106 corresponding to the loaded ad vehicle log at approximately a same point in time (block 1006). By approximately a same point in time, it is understood that an exact same time is not needed, but instead minor time differences are allowable, for example, due to differences between the timestamping of the various meters 104, 110. The amount of allowable time difference depends on the speed of the vehicles, the direction the vehicles are travelling, and other factors. For example, if the panelist vehicle 102 and the ad vehicle 106 are travelling slowly and in the same direction, the time of proximity between them will likely be relatively long and time differences of several seconds may be acceptable. However, if the panelist vehicle 102 and the ad vehicle 106 are travelling quickly in opposite directions, the time of proximity between them will likely be relatively short and time differences of only tenths of seconds may be acceptable. In some examples, the example panelist meter 104 and the example ad vehicle meter 110 may interpolate data points between the times recorded by the timestampers 402, 502 if the time differences between the times recorded by the timestampers 402, 502 is relatively long (e.g., more than a second).

The example proximity analyzer 608 determines whether the distance between the example panelist vehicle 102 and the example ad vehicle 106 at the point in time under analysis is less than a threshold distance (block 1008). The distance between the vehicles can be determined by comparing, for example, the GPS coordinates for the corresponding sets of time-location data. If the example proximity analyzer 608 determines that the distance between the example panelist vehicle 102 and the example ad vehicle 106 at the point in time is not less than the threshold distance (block 1008), then control passes to block 1018.

If the example proximity analyzer 608 determines that the distance between the example panelist vehicle 102 and the example ad vehicle 106 at the point in time is less than the threshold distance (block 1008), then the example duration detector 610 determines whether the example panelist vehicle 102 was within the threshold distance from the example ad vehicle 106 for more than a threshold amount of time (e.g., two seconds) (block 1010). This determination may be made, for example, by determining the set of sequential corresponding ones of the time-location data that satisfy the threshold distance and then subtracting the time for the earliest member of the set from the time for the latest member of the set. If the example duration detector 610 determines that the example panelist vehicle 102 was not within the threshold distance of the example ad vehicle 106 for more than the threshold amount of time (block 1010), then control passes to block 1018.

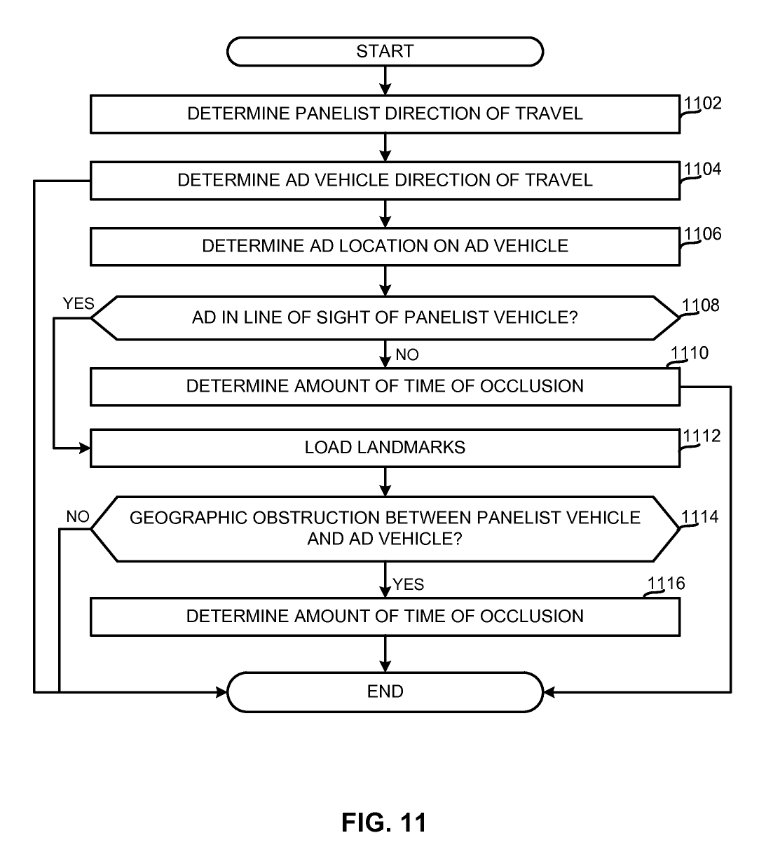

If the example duration detector 610 determines that the example panelist vehicle 102 was within the threshold distance of the example ad vehicle 106 for more than the threshold amount of time (block 1010), then the example occlusion detector 612 determines the amount of time that the example ad vehicle 106 was occluded from the view of the persons in the example panelist vehicle 102 (block 1012). An example manner of implementing block 1012 is discussed in connection with FIG. 11.

The example ad identifier 606 then detects the ad ID of the ad displayed by the example ad display 108 of the example ad vehicle 106 (block 1014). The example credit logic 624 then credits an exposure or exposures to the displayed ad by recording (1) a panelist ID corresponding to the panelist vehicle 102, (2) an ad ID corresponding to the ad displayed by the ad vehicle 106 (e.g., the ad exposed to the panelist vehicle 102 when the panelist vehicle 102 was within the threshold distance of the ad vehicle 106), (3) the ranges of distances between the panelist vehicle 102 and the example ad vehicle 106 (e.g., between 10 feet and 20 feet) as determined by the example proximity analyzer 608, (4) the duration of time that the panelist vehicle 102 was within each range of distances from the ad vehicle 106 (e.g., 0-10 feet, 10-20 feet, 20-30 feet, 30-40 feet) as determined by the example duration detector 610, (5) the duration of time that the panelist vehicle 102 was occluded from the advertising vehicle 106 as determined by the example occlusion detector 612, and (6) any survey, person identification, demographic or other information recorded by the interface 404 of the panelist meter 104 in the panelist vehicle 102 (block 1016). In the illustrated example, the information recorded by the interface 404 includes the number of passengers in the panelist vehicle 102 and the credit logic 624 credits a number of exposures equal to the number of passengers in the panelist vehicle 102. In some examples, the exposures are credited to one or more specific demographic categories.

After the example credit logic 624 credits an exposure (block 1016), the example credit logic 624 determines whether to weight the exposure based on the configuration of the example ad exposure creditor 306 (block 1018).

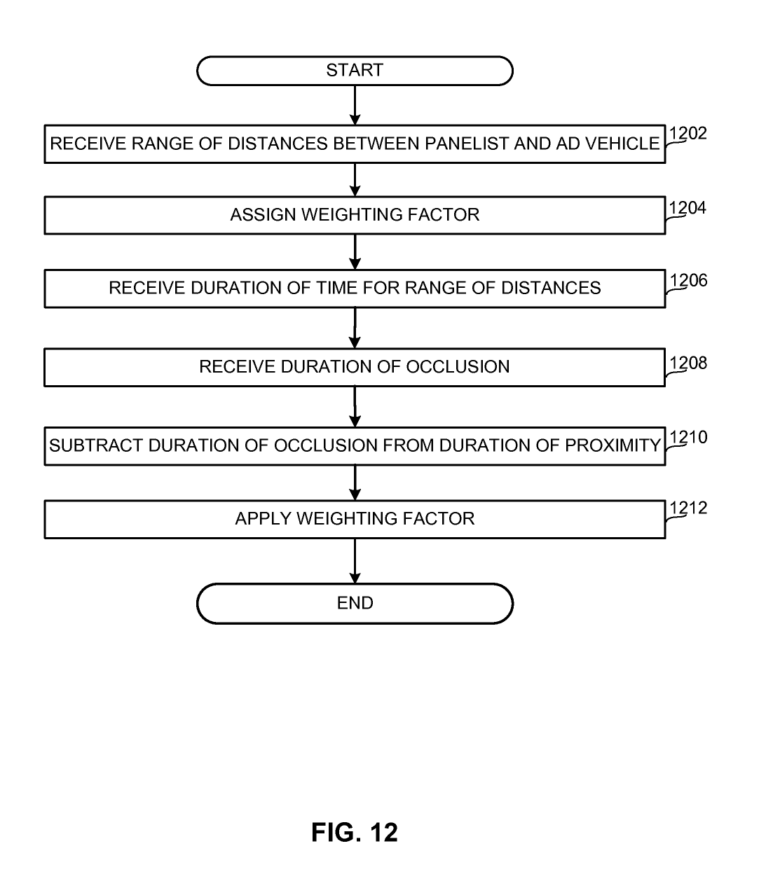

If the example credit logic 624 determines that the exposure should be weighted (block 1018), then the example weight assigner 618 assigns a weight to the exposure (block 101020). An example manner of implementing block 1020 is discussed in connection with FIG. 12.

After the example weight assigner 618 assigns a weight to the exposure (block 1020), or after the example credit logic 624 determines that the exposure should not be weighted (block 1018), or after the example proximity analyzer 608 determines that the example panelist vehicle 102 was not within the threshold distance of the example ad vehicle 106 at the point in time corresponding to the timestamp (block 1008), or after the example duration detector 610 determines that the example panelist vehicle 102 was not within the threshold distance of the example ad vehicle 106 for more than the threshold amount of time (block 1010), the example credit logic 624 determines whether all timestamps in the loaded panelist vehicle log and the loaded advertising vehicle log have been considered (block 1022). If the example credit logic 624 determines that all timestamps have not been considered (block 1022), then control returns to block 1024 and another timestamp is considered. If the example credit logic 624 determines that all timestamps have been considered (block 1022), then the credit logic 624 determines if all example panelist vehicles 102 with panelist logs in the example panelist database 602 have been analyzed (block 1024).

If the example credit logic 624 determines that all example panelist vehicles 102 have not been analyzed (block 1024), then control returns to block 1004 and a panelist log corresponding to another panelist is loaded. If the example credit logic 624 determines that all panelists have been analyzed (block 1024), then the example credit logic 624 determines if all example ad vehicles 106 with ad vehicle logs in the example ad vehicle database 604 have been analyzed (block 1026).

If the example credit logic 624 determines that all example ad vehicles 106 have not been analyzed (block 1026), then control returns to block 1002 and an ad vehicle log corresponding to another ad vehicle 106 is loaded. If the example credit logic 624 determines that all example ad vehicles 106 have been analyzed (block 1026), the example of FIG. 10 ends.

FIG. 11 is a flowchart representative of example machine readable instructions for implementing the example occlusion detector 612 of FIG. 6. The example of FIG. 11 illustrates an example manner of implementing block 1012 of FIG. 10. The example occlusion detector 612 determines the direction of travel of the example panelist vehicle 102 based on the time-location data in the example panelist database 602 (block 1102). The example occlusion detector 612 then determines the direction of travel of the example ad vehicle 106 based on the time-location data in the example ad vehicle database 604 for the corresponding point in time (block 1104). The example occlusion detector 612 then determines where on the example ad vehicle 106 the example ad display 108 is located based on the advertising data (e.g., data identifying where the ad display 108 is located on the ad vehicle 106 and what ad was displayed by the ad display 108 at corresponding points in time) in the example ad vehicle database 604 (block 1106).

The example occlusion detector 612 then determines whether the example ad display 108 was within the line of sight of the example panelist vehicle 102 (e.g., not blocked by the body of the ad vehicle 106 itself) (block 1108). This can be determined by determining whether the example ad display 108 was on the side of the example ad vehicle 106 closest to the example panelist vehicle 102 at the corresponding point in time. If the example occlusion detector 612 determines that the example ad display 108 was not within the line of sight of the example panelist vehicle 102 (block 1108), then the occlusion detector 612 determines that there was an occlusion and the occlusion detector 612 determines the duration of time that the occlusion lasted (block 1110). This determination may be made, for example, by determining the set of sequential corresponding ones of the time-location data where there is an occlusion and then subtracting the time for the earliest member of the set from the time for the latest member of the set.

If the example occlusion detector 612 determines that the example ad display 108 was within the line of sight of the example panelist vehicle 102 (block 1108), then control passes to block 1112 and the occlusion detector 612 loads the location of any nearby structures (i.e., potential geographic obstructions) from the example landmark database 614 and/or potentially obstructing vehicles from the ad vehicle database 604. The example occlusion detector 612 then determines if there were any obstructions (e.g., geographic or vehicles) between the example panelist vehicle 102 and the example ad vehicle 106 (block 1114). This can be determined by, for example, determining if a line drawn between the location of the panelist vehicle 102 and the location of the ad vehicle 106 would pass through the potential obstructions.

If the example occlusion detector 612 determines that there was a geographic and/or vehicle obstruction between the example panelist vehicle 102 and the example ad vehicle 106 (block 1114), then the occlusion detector 612 determines that there was an occlusion and the occlusion detector 612 determines the duration of time that the occlusion lasted (block 1116). This determination may be made, for example, by determining the set of sequential corresponding ones of the time-location data where there is an occlusion and then subtracting the time for the earliest member of the set from the time for the latest member of the set.

If the example occlusion detector 612 determines that there were no geographic obstructions between the example panelist vehicle 102 and the example ad vehicle 106 (block 1114), or after the occlusion detector 612 determines the amount of time of an occlusion (block 1110, block 1116), the example of FIG. 11 ends. For example, control may be returned to block 1014 of FIG. 10.

FIG. 12 is a flowchart representative of example machine readable instructions for implementing the example weight assigner 618 of FIG. 6. The process of FIG. 12 may implement block 1026 of FIG. 10. The example of FIG. 12 begins when the example proximity analyzer 608 sends the example weight assigner 618 a range of distances (e.g., 10 feet to 20 feet) that separated a panelist vehicle 102 and an ad vehicle 106 for a period of time (block 1202). The example weight assigner 618 then assigns a weighting factor based on the range of distances (e.g., 1.5 for 0-10 feet, 1.2 for 10-20 feet, 0.8 for 20-30 feet, 0.5 for 30-40 feet, etc.) (block 1204).

The example duration detector 610 then sends the example weight assigner 618 a duration of time that the panelist vehicle 102 and the ad vehicle 106 were within the range of distances determined by the example proximity analyzer 608 (block 1206). The example occlusion detector 612 then sends the example weight assigner 618 a duration of time (if any) that the ad vehicle 106 was occluded from view of the persons in the panelist vehicle 102 during the corresponding period of time (block 1208). The example weight assigner subtracts the duration of time of the occlusion from the duration of time that the panelist vehicle 102 and the ad vehicle 106 were within the range of distances to determine an amount of time that the persons in the panelist vehicle 102 could see the ad displayed by the ad vehicle 106 (block 1210). The example weight assigner 618 then applies the weighting factor by multiplying the assigned weighting factor by the determined duration of time (block 1212). The example of FIG. 12 then ends.

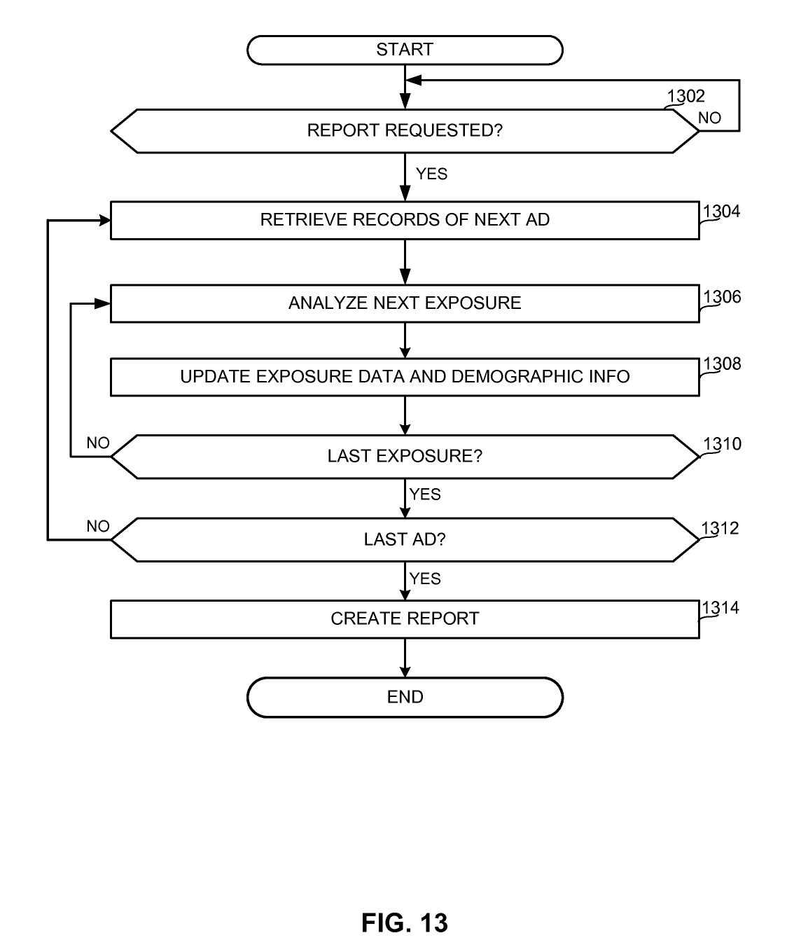

FIG. 13 is a flowchart representative of example machine readable instructions for implementing the example report generator 622 of FIG. 6. The example of FIG. 13 begins when the example report generator 622 detects whether a report has been requested (block 1302). Once a report has been requested, the example report generator 622 retrieves the records relating to an ad that is to be included in the report from the example views database 616 (block 1304). The example report generator 622 then analyzes the data from the retrieved records relating to a first exposure of the ad (e.g., exposure data) (block 1306). The example report generator 622 then updates the data related to the ad based on the exposure data and the type of report requested (block 1308). For example, if the report to be generated includes the number of exposures to the ad, the example report generator 622 updates the number of exposures to the ad. If the report to be generated includes demographic data about the people exposed to the ad, the example report generator 622 retrieves the demographic data related to the exposure by accessing the example demographic analyzer 620.

The example report generator 622 then determines whether the analyzed exposure was the last exposure related to the ad (block 1310). If the example report generator 622 determines that the analyzed exposure was not the last exposure related to the ad (block 1310), then control returns to block 1306 and the report generator 622 analyzes another exposure related to the ad. If the example report generator 622 determines that the analyzed exposure was the last exposure related to the ad (block 1310), then the report generator 622 determines whether the ad was the last ad to be included in the report (block 1312).

If the example report generator 622 determines that the ad was not the last ad to be included in the report (block 1312), then control returns to block 1304 and the report generator 622 retrieves the records of the next ad to be included in the report. If the example report generator 622 determines that the ad was the last ad to be included in the report (block 1312), then the report generator 622 creates the report (block 1314). The example of FIG. 13 then ends.

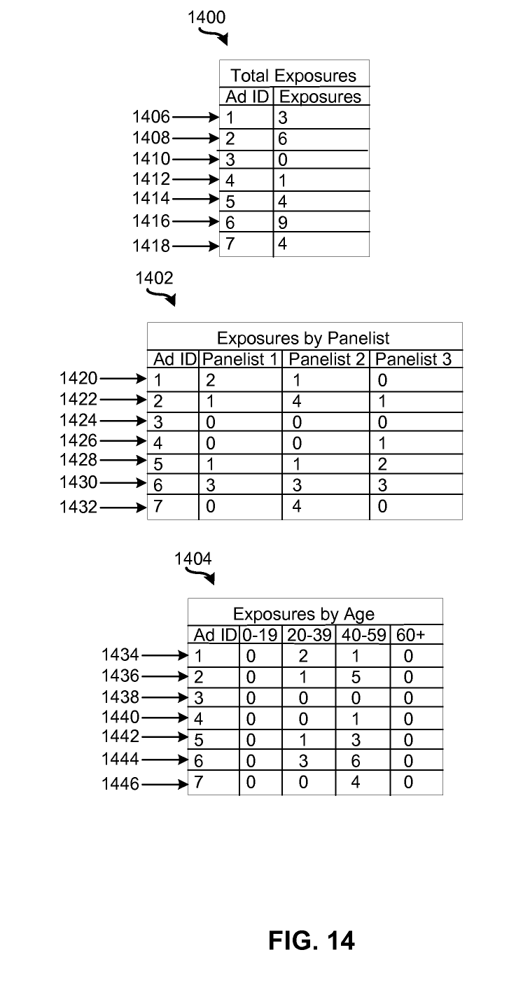

FIG. 14 illustrates an example report generated by the example report generator 622. The example report illustrated in FIG. 14 relates to example data about three panelists (with panelist IDs 1, 2 and 3) and seven ads (with ad IDs 1, 2, 3, 4, 5, 6 and 7). The example table 1400 lists the total number of exposure to each of the seven ads. Column 1406 illustrates that the ad with ad ID 1 had 3 exposures, column 1408 illustrates that the ad with ad ID 2 had 6 exposures, column 1410 illustrates that the ad with ad ID 3 had 0 exposures, column 1412 illustrates that the ad with ad ID 4 had 1 exposures, column 1414 illustrates that the ad with ad ID 5 had 4 exposures, column 1416 illustrates that the ad with ad ID 6 had 9 exposures, and column 1418 illustrates that the ad with ad ID 7 had 4 exposures.

The example table 1402 lists the total number of exposures of each of the seven ads to each of the three panelists. Column 1420 illustrates that the ad with ad ID 1 had 2 exposures to the panelist vehicle 102 with panelist ID 1, 1 exposure to the panelist vehicle 102 with panelist ID 2 and 0 exposures to the panelist 120 with panelist ID 3. Column 1422 illustrates that the ad with ad ID 2 had 2 exposures to the panelist vehicle 102 with panelist ID 1, 4 exposures to the panelist vehicle 102 with panelist ID 2 and 1 exposure to the panelist 120 with panelist ID 3. Column 1424 illustrates that the ad with ad ID 3 had 0 exposures to the panelist vehicle 102 with panelist ID 1, 0 exposures to the panelist vehicle 102 with panelist ID 2 and 0 exposures to the panelist 120 with panelist ID 3. Column 1426 illustrates that the ad with ad ID 4 had 0 exposures to the panelist vehicle 102 with panelist ID 1, 0 exposures to the panelist vehicle 102 with panelist ID 2 and 1 exposure to the panelist 120 with panelist ID 3. Column 1428 illustrates that the ad with ad ID 5 had 1 exposure to the panelist vehicle 102 with panelist ID 1, 1 exposure to the panelist vehicle 102 with panelist ID 2 and 2 exposures to the panelist 120 with panelist ID 3. Column 1430 illustrates that the ad with ad ID 6 had 3 exposures to the panelist vehicle 102 with panelist ID 1, 3 exposures to the panelist vehicle 102 with panelist ID 2 and 3 exposures to the panelist 120 with panelist ID 3. Column 1432 illustrates that the ad with ad ID 7 had 0 exposures to the panelist vehicle 102 with panelist ID 1, 4 exposures to the panelist vehicle 102 with panelist ID 2 and 0 exposures to the panelist 120 with panelist ID 3.

The example table 1404 illustrates the number of exposures of each of the seven ads by panelists according to the age of the panelist. In the example of FIG. 14, the panelist 120 with panelist ID is in the age 20-39 bracket, and the panelists 120 with panelist IDs 2 and 3 are both in the age 40-59 age. Column 1434 illustrates that the ad with ad ID 1 had 2 exposures to panelists 120 in the age 20-39 bracket and 1 exposure to panelists 120 in the age 40-59 bracket. Column 1436 illustrates that the ad with ad ID 2 had 1 exposure to panelists 120 in the age 20-39 bracket and 5 exposures to panelists 120 in the age 40-59 bracket. Column 1438 illustrates that the ad with ad ID 3 did not have any exposures to any panelists in any age bracket. Column 1440 illustrates that the ad with ad ID 4 had 1 exposure to panelists 120 in the age 40-59 bracket. Column 1442 illustrates that the ad with ad ID 5 had 1 exposure to panelists 120 in the age 20-39 bracket and 3 exposures to panelists 120 in the age 40-59 bracket. Column 1444 illustrates that the ad with ad ID 6 had 3 exposures to panelists 120 in the age 20-39 bracket and 6 exposures to panelists 120 in the age 40-59 bracket. Column 1446 illustrates that the ad with ad ID 7 had 4 exposures to panelists 120 in the age 40-59 bracket.

The example report generator 622 may generate tables other than the types of tables illustrated in FIG. 14, such as tables based on the duration of ad exposure, tables based on exposures during certain time periods, tables based on exposures during certain dates, etc.

FIG. 15 is a block diagram of an example processor platform 1500 capable of executing the instructions of FIGS. 7-12 and/or 13 to implement the example panelist meter 104 of FIGS. 1, 3 and 4, the example ad vehicle meter 110 of FIGS. 1, 3 and 5, the example data receiver 600 of FIG. 6, the example ad exposure creditor 306 of FIGS. 3 and 6, the example occlusion detector 612 of FIG. 6, the example weight assigner 618 of FIG. 6, and the example report generator 622 of FIG. 6. The processor platform 1500 can be, for example, a server, a personal computer, a mobile device (e.g., a cell phone, a smart phone, a tablet such as an iPad™), or any other type of computing device.

The processor platform 1500 of the illustrated example includes a processor 1512. The processor 1012 of the illustrated example is hardware. For example, the processor 1512 can be implemented by one or more integrated circuits, logic circuits, microprocessors or controllers from any desired family or manufacturer.

The processor 1512 of the illustrated example includes a local memory 1513 (e.g., a cache). The processor 1512 of the illustrated example is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a universal serial bus (USB), and/or a PCI express interface.

In the illustrated example, one or more input devices 1522 are connected to the interface circuit 1520. The input device(s) 1522 permit a user to enter data and commands into the processor 1512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1524 are also connected to the interface circuit 1520 of the illustrated example. The output devices 1524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1520 of the illustrated example, thus, typically includes a graphics driver card.

The interface circuit 1520 of the illustrated example also includes a communication device such as a transmitter, a receiver, a transceiver, a modem and/or network interface card to facilitate exchange of data with external machines (e.g., computing devices of any kind) via a network 1526 (e.g., an Ethernet connection, a digital subscriber line (DSL), a telephone line, coaxial cable, a cellular telephone system, etc.).

The processor platform 1500 of the illustrated example also includes one or more mass storage devices 1528 for storing software and/or data. Examples of such mass storage devices 1528 include floppy disk drives, hard drive disks, compact disk drives, Blu-ray disk drives, RAID systems, and digital versatile disk (DVD) drives.

The coded instructions 1532 of FIGS. 7-13 may be stored in the mass storage device 1528, in the volatile memory 1514, in the non-volatile memory 1516, and/or on a removable tangible computer readable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A method comprising:
accessing first time-location data identifying a first set of physical locations of a first vehicle at corresponding points in time;
accessing second time-location data identifying a second set of physical locations of a second vehicle at corresponding points in time, wherein the second vehicle displays a first advertisement; and
determining whether to credit the first vehicle with an exposure to the first advertisement based on the first time-location data and the second time-location data.

2. A method as defined in claim 1, wherein the second vehicle alternates display of a second advertisement different from the first advertisement with display of the first advertisement; and
determining whether to credit the first vehicle with the exposure comprises detecting which of the first advertisement or the second advertisement was exposed to the first vehicle.

3. A method as defined in claim 2, wherein determining whether to credit the first vehicle with the exposure comprises detecting which of the first advertisement or the second advertisement was exposed to the first vehicle when the first vehicle was within a threshold distance of the second vehicle.

4. A method as defined in claim 3, wherein detecting which of the first advertisement or the second advertisement was exposed to the first vehicle when the first vehicle was within the threshold distance of the second vehicle further comprises accessing advertisement data identifying which of the first advertisement or the second advertisement was displayed by the second vehicle at the corresponding points in time included in the second time-location data.

5. A method as defined in claim 1, wherein determining whether to credit the first vehicle with the exposure further comprises determining whether the first vehicle was within a threshold distance of the second vehicle.

6. A method as defined in claim 5, wherein determining whether to credit the first vehicle with the exposure further comprises determining whether the first vehicle was within the threshold distance for more than a threshold amount of time.

7. A method as defined in claim 1, wherein determining whether to credit the first vehicle with the exposure further comprises determining whether the first advertisement on the second vehicle was within a line of sight of the first vehicle.

8. (canceled)

9. A method as defined in claim 7, wherein determining whether the first advertisement was within the line of sight of the first vehicle further comprises detecting whether the second vehicle was occluded from view of the first vehicle by a geographic obstruction.

10. A method as defined in claim 1, further comprising:
determining a number of passengers in the first vehicle; and
crediting a number of exposures to the first advertisement based on the number of passengers in the first vehicle.

11.-16. (canceled)

17. A method as defined in claim 1, wherein crediting the first vehicle with the exposure further comprises assigning a weighting factor for the exposure based on at least one of (1) a distance between the first vehicle and the second vehicle and (2) an amount of time that the first vehicle was within a threshold distance of the second vehicle.

18. A tangible machine readable storage medium comprising instructions that, when executed, cause a machine to at least:
access first time-location data identifying a first set of physical locations of a first vehicle at corresponding points in time;
access second time-location data identifying a second set of physical locations of a second vehicle at corresponding points in time, wherein the second vehicle displays a first advertisement; and
determine whether to credit the first vehicle with an exposure to the first advertisement based on the first time-location data and the second time-location data.

19. A machine readable storage medium as defined in claim 18, wherein the second vehicle is to alternate display of a second advertisement different from the first advertisement with display of the first advertisement; and
the instructions cause the machine to determine whether to credit the first vehicle with the exposure by detecting which of the first advertisement or the second advertisement was exposed to the first vehicle.

20. A machine readable storage medium as defined in claim 19, wherein the instructions cause the machine to determine whether to credit the first vehicle with the exposure by detecting which of the first advertisement or the second advertisement was exposed to the first vehicle when the first vehicle was within a threshold distance of the second vehicle.

21. A machine readable storage medium as defined in claim 20, wherein the instructions cause the machine to detect which of the first advertisement or the second advertisement was exposed to the first vehicle when the first vehicle was within the threshold distance of the second vehicle by accessing advertisement data identifying which of the first advertisement or the second advertisement was displayed by the second vehicle at the corresponding points in time included in the second time-location data.

22. A machine readable storage medium as defined in claim 18, wherein the instructions cause the machine to determine whether to credit the first vehicle with the exposure by determining whether the first vehicle was within a threshold distance of the second vehicle.

23. A machine readable storage medium as defined in claim 22, wherein the instructions cause the machine to determine whether to credit the first vehicle with the exposure by determining whether the first vehicle was within the threshold distance for more than a threshold amount of time.

24. A machine readable storage medium as defined in claim 18, wherein the instructions cause the machine to determine whether to credit the first vehicle with the exposure by determining whether the first advertisement on the second vehicle was within a line of sight of the first vehicle.

25. (canceled)

26. A machine readable storage medium as defined in claim 24, wherein the instructions cause the machine to determine whether the first advertisement was within the line of sight of the first vehicle by detecting whether the second vehicle was occluded from view by a passenger in the first vehicle by a geographic obstruction.

27. A machine readable storage medium as defined in claim 18, wherein the instructions, when executed, further cause the machine to:
determine a number of passengers in the first vehicle; and
credit a number of exposures to the first advertisement based on the number of passengers in the first vehicle.

28.-33. (canceled)

34. A machine readable storage medium as defined in claim 18, wherein the instructions cause the machine to credit the first vehicle with the exposure by assigning a weighting factor to the exposure based on at least one of (1) a distance between the first vehicle and the second vehicle and (2) an amount of time that the first vehicle was within a threshold distance of the second vehicle

35.-51. (canceled)

52. An apparatus comprising:
a panelist database containing first time-location data identifying a first set of physical locations of a first vehicle at corresponding points in time;
an advertising vehicle database containing second time-location data identifying a second set of physical locations of a second vehicle at corresponding points in time, the second vehicle to display a first advertisement; and
credit logic to determine whether to credit the first vehicle with an exposure to the first advertisement based on the first time-location data and the second time-location data.

53. An apparatus as defined in claim 52, wherein the credit logic comprises a proximity analyzer to determine whether the first vehicle was within a threshold distance of the second vehicle, the credit logic is to determine whether to credit the first vehicle with the exposure based on the output of the proximity analyzer.

54. An apparatus as defined in claim 53, wherein the second vehicle alternates display of a second advertisement different from the first advertisement with display of the first advertisement; and
the advertising vehicle database stores advertising data that identifies which of the first advertisement or the second advertisement was displayed by the second vehicle at the corresponding points in time included in the second time-location data.

55. An apparatus as defined in claim 54, further comprising an ad identifier to determine which of the first advertisement or the second advertisement was exposed to the first vehicle.

56.-57. (canceled)

58. An apparatus as defined in claim 53, wherein the credit logic further comprises a duration detector to determine whether the first vehicle was within the threshold distance for more than a threshold amount of time, and the credit logic is to determine whether to credit the first vehicle with the exposure based on the determination of the duration detector.

59. An apparatus as defined in claim 53, further comprises an occlusion detector to determine whether the first advertisement on the second vehicle was within a line of sight of the first vehicle and the credit logic is to determine whether to credit the first vehicle with the exposure based on the determination of the occlusion detector.

60. (canceled)

61. An apparatus as defined in claim 59, further comprising a landmark database containing locations of geographic obstructions, and wherein the occlusion detector is to detect whether the second vehicle was occluded from the first vehicle by a geographic obstruction by accessing the landmark database, the first time-location data and the second time-location data.

62.-63. (canceled)

64. An apparatus as defined in claim 53, further comprising a weight assigner to assign a weighting factor to the exposure based on at least one of (1) a distance between the first and second vehicle, and (2) an amount of time that the first vehicle was within a threshold distance of the second vehicle.

65. An apparatus as defined in claim 53, further comprising a views database to store information about the exposure.

66. An apparatus as defined in claim 65, further comprising a report generator to generate a report based on the information in the views database.
